(19) United States
(12) Patent Application Publication
(10) Pub. No.: US 2015/0020384 A1
(43) Pub. Date: Jan. 22, 2015

(54) Method for Crimping Terminal to Wire and Crimping Terminal

(71) Applicant: Yazaki Corporation, Tokyo (JP)

(72) Inventor: Toshihiko Yamamoto, Makinohara-shi (JP)

(73) Assignee: YAZAKI CORPORATION, Tokyo (JP)

(21) Appl. No.: 14/506,774

(22) Filed: Oct. 6, 2014

Related U.S. Application Data
(63) Continuation of application No. PCT/JP13/61003, filed on Apr. 5, 2013.

(30) Foreign Application Priority Data
Apr. 5, 2012 (JP) 2012-086249

(51) Int. Cl. H01R 43/048; H01R 4/18

(52) U.S. Cl. CPC H01R 43/048; H01R 4/18
USPC 29/863

(57) ABSTRACT

There is provided a method for crimping a crimping terminal to a wire. The crimping terminal includes a conductor crimping part configured to crimp a conductor part of the wire. A thermoplastic resin layer is formed on an area of an inner surface of the conductor crimping part so as to define a contact area on which the thermoplastic resin layer is not formed. The conductor crimping part, on which the thermoplastic resin layer is formed, is crimped to the conductor part so that the contact area comes in contact with the conductor part. The conductor crimping part crimped to the conductor part is heated at a temperature at which the thermoplastic resin layer is melted. The contact area is surrounded by the thermoplastic resin layer so as to be sealed after the heating.

### CROSS REFERENCE TO RELATED APPLICATIONS

This application is a continuation of PCT application No. PCT/JP13/061003, which was filed on Apr. 5, 2013 based on Japanese Patent Application (No. 2012-086249) filed on Apr. 5, 2012, the contents of which are incorporated herein by reference.

### BACKGROUND OF THE INVENTION

1. Field of the Invention

The present invention is related to a method of crimping a crimping terminal to a wire, to provide a wire with a crimping terminal in which the crimping terminal is crimped to a conductor part of the wire.

2. Description of the Related Art

There is a wire with crimping terminal, which has a wire and a crimping terminal crimped to a conductor part exposed at an end of the wire. It is important for the crimping terminal to improve connection stability between the crimping terminal and the wire. For example, in PTL 1, a method for crimping the crimping terminal to the wire is proposed. The method increases the connection stability between the crimping terminal and the conductor part by partially changing a thickness of plating formed on an inner surface of the crimping terminal.

In the method for crimping the crimping terminal to the wire described in PTL 1, the thickness of tin plating on the inner surface of a conductor crimping part of the crimping terminal is set to be higher, and the conductor crimping part is crimped to the conductor part.

### CITATION LIST

### Patent Literature

[PTL 1] JP-A-2009-152052

### SUMMARY OF THE INVENTION

In the method for crimping the crimping terminal to the wire described in PTL 1, because the conductor part is not sealed to be separated from the atmosphere, an oxidation layer may be formed on the conductor part. Thereby, a contact resistance between the crimping terminal and the conductor part may be increased. As a result, the connection stability may decrease.

It is therefore one advantageous aspect of the present invention to provide a method for crimping a crimping terminal to a wire so that the connection stability can be prevented from decreasing.

According to one advantage of the invention, there is provided a method for crimping a crimping terminal to a wire, the crimping terminal including a conductor crimping part configured to crimp a conductor part of the wire, the method comprising:
forming a thermoplastic resin layer on an area of an inner surface of the conductor crimping part so as to define a contact area on which the thermoplastic resin layer is not formed;
crimping the conductor crimping part, on which the thermoplastic resin layer is formed, to the conductor part so that the contact area comes in contact with the conductor part; and
heating the conductor crimping part crimped to the conductor part at a temperature at which the thermoplastic resin layer is melted,
wherein the contact area is surrounded by the thermoplastic resin layer so as to be sealed after the heating.

The method may further comprise punching a flat member to form a plurality of crimping terminals, wherein the forming of the thermoplastic resin layer is performed before the punching.

According to another advantage of the invention, there is provided a crimping terminal, configured to crimp a conductor part of a wire, the crimping terminal comprising:
a conductor crimping part, configured to crimp the conductor part of the wire; and
a thermoplastic resin layer, formed on an inner surface of the conductor crimping part, wherein
a contact area, on which the thermoplastic resin layer is not formed, is provided in the inner surface of the conductor crimping part, and
the contact area is surrounded by the thermoplastic resin layer, so as to be sealed in a state where the conductor part is crimped to the conductor crimping part.

In the method for crimping the crimping terminal to the wire according to the present invention, in a state that a part of the inner surface of the crimping terminal, where the contact area is provided, contacts the conductor part, the thermoplastic resin is filled between an outer peripheral surface of the conductor part and the inner surface of the crimping terminal at the crimping side so as to surround the contact part. Therefore, the contact part between the crimping terminal and the conductor part is sealed and is shielded from the atmosphere so that an oxidation layer can be prevented from being formed at the contact part. As a result, the connection stability can be prevented from decreasing.

In the method for crimping the crimping terminal to the wire according to the present invention, the thermoplastic resin layer can be collectively formed on the plurality of crimping terminals by applying the thermoplastic resin to the flat member before the plurality of crimping terminals are punched. Therefore, the thermoplastic resin layer can be easily formed on the plurality of crimping terminals.

### BRIEF DESCRIPTION OF THE DRAWINGS

FIG. 1 is a perspective view of a wire with crimping terminal, which is manufactured by a method for crimping the crimping terminal to the wire according to an embodiment of the present invention.

FIG. 2 is an enlarged view showing an area around a conductor crimping part of the crimping terminal shown in FIG. 1.

FIG. 3 is a perspective view showing a state before the crimping terminal shown in FIG. 1 is crimped to the wire.

FIG. 4 is a figure, which is viewed from the direction of an arrow in FIG. 3, of the crimping terminal shown in FIG. 3.

FIGS. 5A to 5D show procedures for crimping the crimping terminal to the wire.

### DETAILED DESCRIPTION OF THE EXEMPLARY EMBODIMENTS

A preferred embodiment of the method for crimping the crimping terminal to the wire according to the invention will be described in detail with reference to the drawings as follows.

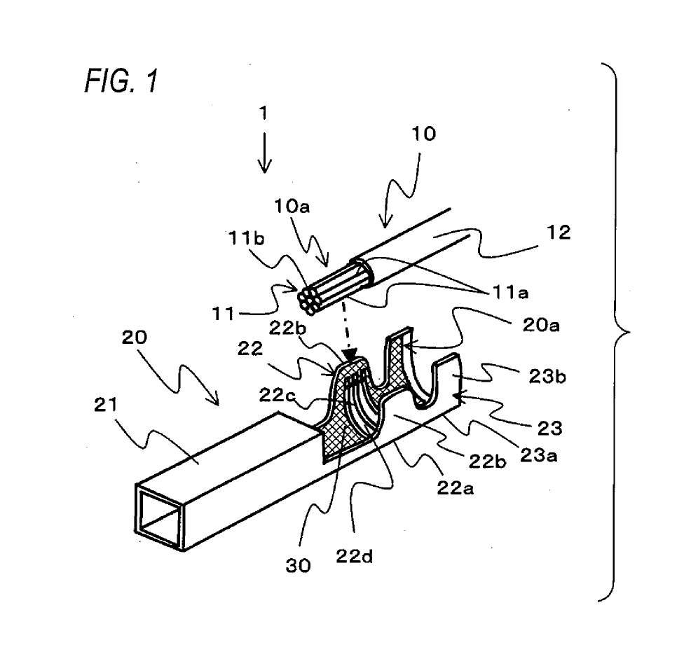

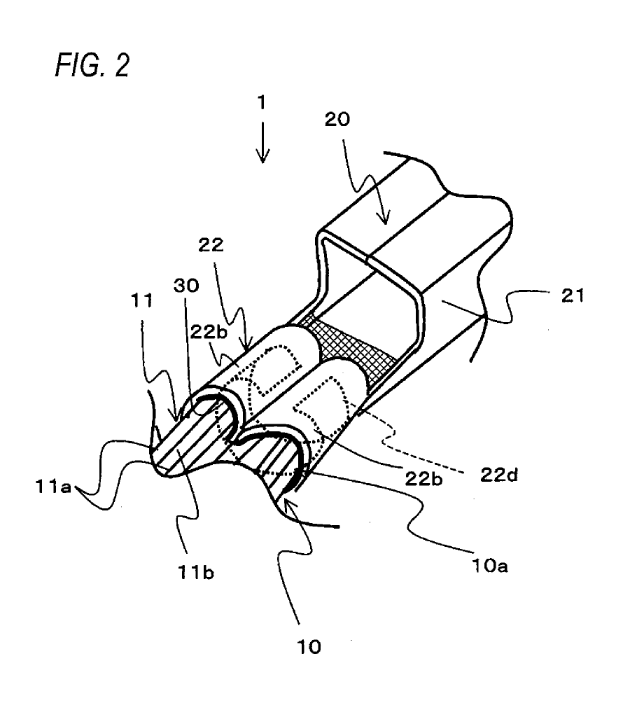

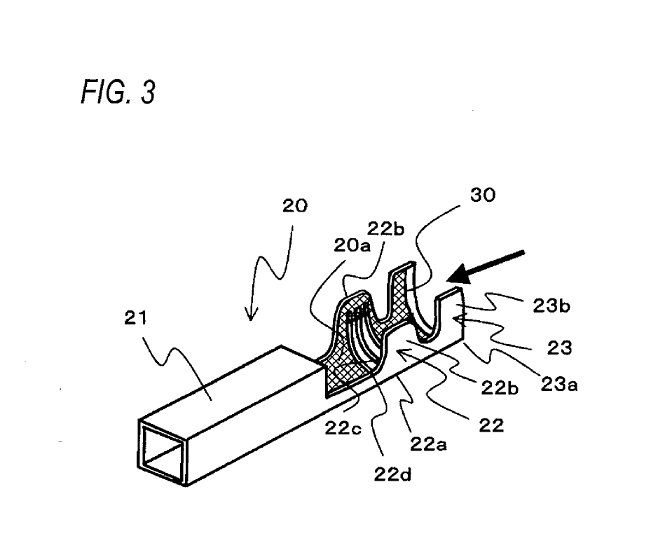

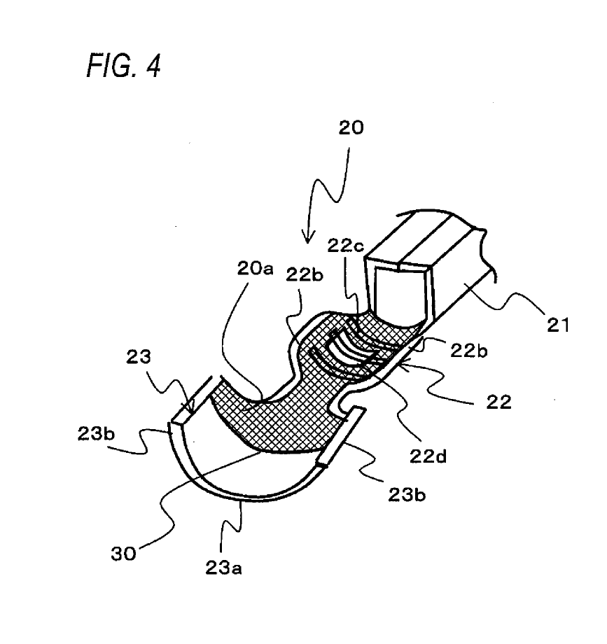

FIG. 1 is a perspective view of a wire with crimping terminal 1 which is manufactured by the method for crimping a crimping terminal to a wire according to an embodiment of the invention. FIG. 2 is an enlarged view of an area around a conductor crimping part 22 of the crimping terminal with wire 1 shown in FIG. 1. FIG. 3 is a perspective view which shows a state before a crimping terminal 20 shown in FIG. 1 is crimped to a wire 10. FIG. 4 is a figure, which is viewed from the direction of an arrow in FIG. 3, of the crimping terminal 20 shown in FIG. 3.

The wire with crimping terminal 1 manufactured by the method the invention has the wire 10 and a crimping terminal 20. The wire 10 is made by covering a conductor part 11 with an insulative sheath 12. The crimping terminal 20 includes the conductor crimping part 22 which is crimped to the conductor part 11.

The wire 10 is made by covering the conductor part 11 with the insulative sheath 12. The conductor part 11 is made by bundling a plurality of metal strands 11a.

The metal strands 11a are made of, for example, aluminum material, and a plurality of the metal strands 11a are bundled to function as the conductor part 11.

The insulative sheath 12 is made of insulative materials such as synthetic resin, and protects the conductor part 11 by covering the outer peripheral surface 11b of the conductor part 11 so that the conductor part 11 can be insulated.

The wire 10 is so formed that the crimping terminal 20 contacts the conductor part 11 that is exposed by removing the insulative sheath 12 at an end part 10a of the wire 10.

The crimping terminal 20 is manufactured by, for example, punching a flat member with a die, and bending the punched flat member to form a plurality of crimping terminals 20. The flat member is made of copper alloy or the like.

The crimping terminal 20 is a female terminal. The crimping terminal includes a mating connecting part 21 to be connected with a mating connecting terminal not shown in the figure, the conductor crimping part 22 which is crimped to the exposed conductor part 11, and an insulative sheath crimping part 23 which is crimped to the insulative sheath 12 of the wire 10.

The mating connecting part 21 has a box-like shape. An elastic contact strip not shown in the figure is formed inside the mating connecting part 21. The mating connecting part 21 is a part that connects a male terminal, which is not shown in the figure and becomes the mating connecting terminal, through the elastic contact strip.

The conductor crimping part 22 is formed between the mating connecting part 21 and the insulative sheath crimping part 23, and is a part where the crimping terminal 20 and the conductor part 11 contact each other. The conductor crimping part 22 has a base 22a including a wall that forms a bottom surface, and a pair of crimping pieces 22b which are formed by raising two edges of the base 22a into a paddle form. The pair of crimping pieces 22b are crimped to the conductor part 11 by being bent inwards by using a crimping jig.

A plurality of grooves 22c are formed on a surface 20a of the conductor crimping part 22 at the crimping side. The grooves 22c are called serrations. The grooves 22c increase a contact area with the conductor part 11 or improves holing force by the conductor crimping part 22 to hold the conductor part 11.

In the embodiment, the grooves 22c are formed in the conductor crimping part 22. However, the grooves 22c may be omitted from the conductor crimping part 22.

An upper die (not shown in the figure) referred to as a crimper and a lower die (not shown in the figure) referred to as an anvil are used as the crimping jig.

The conductor crimping part 22 is crushed by the upper die and the lower die into a predetermined shape, so that the conductor crimping part 22 is crimped to the conductor part 11.

Among the surface 20a of the crimping terminal 20 at the crimping side, a layer of thermoplastic resin 30 is formed in an area of the surface 20a of the conductor crimping part 22 except a part of the surface 20a of the conductor crimping part 22 as a non-forming part 22d (a contact area). The thermoplastic resin 30 is also formed in an area of the surface 20a around the above area. The thermoplastic resin 30 includes synthetic resin such as polyethylene, polypropylene or the like. The thermoplastic resin layer formed by the thermoplastic resin 30 is indicated by cross-hatching lines in the drawings.

In the crimping terminal 20, when the conductor crimping part 22 is crimped to the conductor part 11 and is heated at a temperature at which the thermoplastic resin 30 is melted, the thermoplastic resin 30 is filled between the outer peripheral surface 11b of the conductor part 11 and the surface 20a of the crimping terminal 20 at the crimping side. The thermoplastic resin 30 surrounds the contact part where the non-forming part 22d is exposed to contact the conductor part 11.

The insulative sheath crimping part 23 forms an end opposite to the mating connecting part 21 of the crimping terminal 20, and is a part which holds the wire 10 by being crimped to the insulative sheath 12. The insulative sheath crimping part 23 has a base 23a which continues to the base 22a of the conductor crimping part 22, and a pair of crimping pieces 23b which are formed by raising two edges of the base 23a. The pair of crimping pieces 23b are crimped to the insulative sheath 12 by being bent inwards by using the crimping jig not shown in the figure.

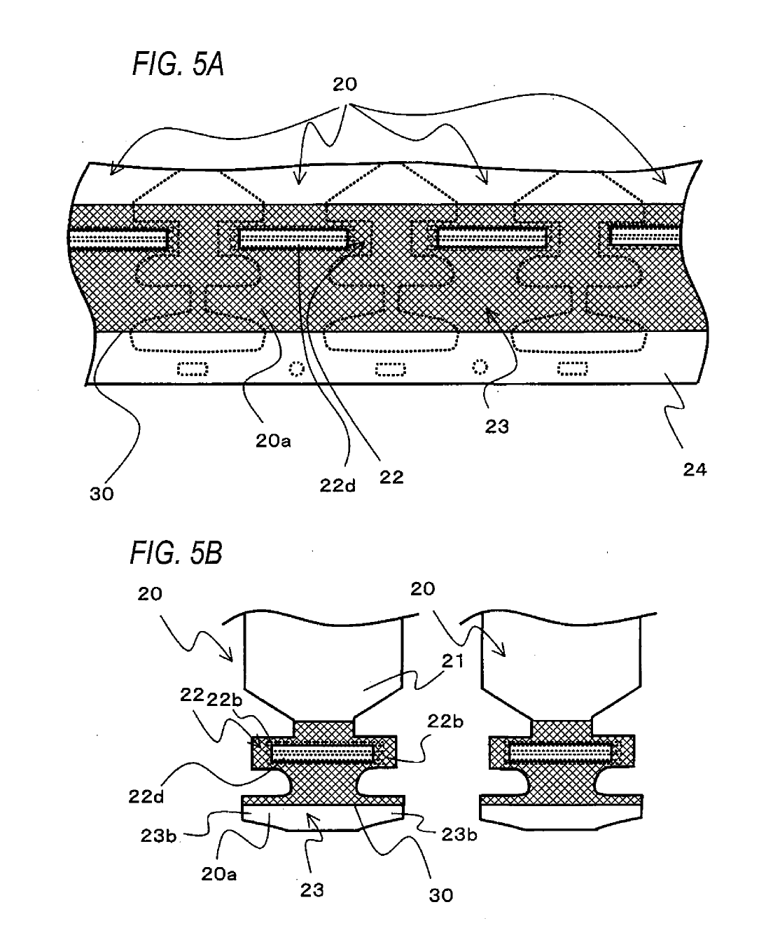

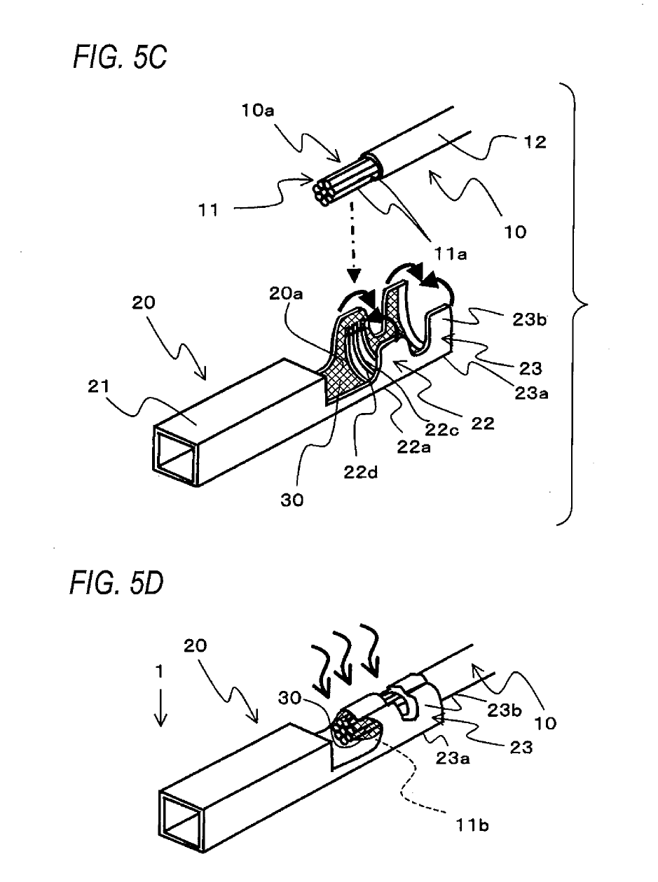

Next, a method for crimping the crimping terminal 20 of the crimping terminal with wire 1 to the wire 10 is described by using FIGS. 5A to 5D. FIGS. 5A to 5D show procedures for crimping the crimping terminal 20 of the crimping terminal with wire 1 to the wire 10. In FIG. 5A, a periphery of a part to be punched including outer shapes of crimping terminals 20 are shown with broken lines.

First, an operator forms a layer of the thermoplastic resin 30 in an area of the surface 20a of the conductor crimping part 22 except a part of the surface 20a of the conductor crimping part 22 as the non-forming part 22d and an area of the surface 20a around the above area, among the surface 20a of the crimping terminal 20 at the crimping side (refer to FIG. 5A).

In this resin forming process, the thermoplastic resin 30 is coated onto the flat member 24 before a plurality of crimping terminals 20 are punched. Before the thermoplastic resin 30 is coated, masks are put onto a plurality of positions where the non-forming parts 22d of the conductor crimping parts 22 are formed.

Thus, the thermoplastic resin 30 is collectively coated onto the plurality of crimping terminals 20 by applying the thermoplastic resin 30 to the flat member 24 before the plurality of crimping terminals 20 are punched.

In this embodiment, the non-forming part 22d has a rectangular shape. However, the non-forming part 22d may have other shapes as long as an area of the surface 20a of the conductor crimping part 22 to contact the conductor part 11 is not covered by the thermoplastic resin 30. For example, the non-forming part 22d may have an oval shape.

Then, the operator performs the process of punching the flat member 24 to form the crimping terminals 20 (refer to FIG. 5B). A plurality of crimping terminals 20 are formed into a predetermined outer shape by the punching process. The punching process is automatically performed by using, for example, a die pressing device not shown in the figure.

Then, the operator crimps the crimping terminal 20 to the wire 10 (refer to FIG. 5C). Thereby, the conductor part 11 and the crimping terminal 20 are connected. More specifically, the part of the surface 22a of the conductor crimping part 22 where the non-forming part 22d is exposed from the thermoplastic resin 30 contacts the conductor part 11.

Then, the operator heats the conductor crimping part 22 with the conductor part 11 at a temperature at which the thermoplastic resin 30 is melted (refer to FIG. 5D). Thereby, the thermoplastic resin 30 is filled between the conductor part 11 and the crimping terminal 20 to surround the non-forming part 22d. That is, the part of the surface 22a of the conductor crimping part 22 where the non-forming part 22d is exposed contacts the conductor part 11, and the thermoplastic resin 30 is filled so that the contact part of the exposed part of the surface 22a and the conductor part 11 is sealed. The melted thermoplastic resin 30 is hardened by returning to a normal temperature state. The melted thermoplastic resin 30 may be hardened by being cooled off forcibly.

In the method for crimping the crimping terminal to the wire according to the embodiment of the invention, in a state where the part of the surface 20a of the crimping terminal 22 at the crimping side, where the non-forming part 22d is exposed, contacts the conductor part 11, the thermoplastic resin 30 is filled between the outer peripheral surface 11b of the conductor part 11 and the surface 20a of the crimping terminal 20 at the crimping side to surround the contact part. Therefore, the contact part of the crimping terminal 20 and the conductor part 11 is sealed and is shielded from the atmosphere so that an oxidation layer can be prevented from being formed at the contact part, and as a result, the connection stability can be prevented from decreasing.

In the method for crimping the crimping terminal to the wire according to the embodiment of the present invention, the thermoplastic resin 30 can be collectively formed onto the plurality of crimping terminals 20 by applying the thermoplastic resin 30 to the flat member 24 before the plurality of crimping terminals 20 are punched. Therefore, the thermoplastic resin can be easily coated onto the plurality of crimping terminals 20.

In the crimping terminal 20 according to the embodiment of the invention, the crimping terminal 20 includes the conductor crimping part 22, a thermoplastic resin layer made of the thermoplastic resin 30, and the contact area on which the thermoplastic resin layer is not formed. The conductor crimping part 22 crimps the conductor part 11 of the wire 10. The thermoplastic resin layer is formed on an inner surface of the conductor crimping part 22. The contact area is provided in the inner surface of the conductor crimping part 21. The contact area is surrounded by the thermoplastic resin layer, so as to be sealed in a state where the conductor part 11 is crimped to the conductor crimping part 21.

In the method for crimping the crimping terminal to the wire according to the embodiment of the invention, the conductor part 11 is made by bundling a plurality of metal strands 11a. However the conductor part 11 may be made of a single core strand.

In the method for crimping the crimping terminal to the wire according to the embodiment of the invention, the crimping terminal 20 is a female terminal. to the crimping terminal 20 may be used as other crimping terminals as long as the crimping terminal is crimped to the conductor part 11 of the wire 10. For example, a male terminal may be used.

The invention accomplished by the inventor is described in detail based on the above embodiment of the invention, but the present invention is not limited to the above embodiment of the invention and can be modified in various ways without departing from the spirit of the invention.

According to a method for crimping a crimping terminal to a wire, the connection stability can be prevented from decreasing.

What is claimed is:

1. A method for crimping a crimping terminal to a wire, the crimping terminal including a conductor crimping part configured to crimp a conductor part of the wire, the method comprising:
forming a thermoplastic resin layer on an area of an inner surface of the conductor crimping part so as to define a contact area on which the thermoplastic resin layer is not formed;
crimping the conductor crimping part, on which the thermoplastic resin layer is formed, to the conductor part so that the contact area comes in contact with the conductor part; and
heating the conductor crimping part crimped to the conductor part at a temperature at which the thermoplastic resin layer is melted,
wherein the contact area is surrounded by the thermoplastic resin layer so as to be sealed after the heating.

2. The method as set forth in claim 1, further comprising:
punching a flat member to form a plurality of crimping terminals,
wherein the forming of the thermoplastic resin layer is performed before the punching.
